(19) United States
(12) Patent Application Publication
(10) Pub. No.: US 2010/0173275 A1
(43) Pub. Date: Jul. 8, 2010

(54) IMAGE GENERATION SYSTEM FOR DISPLAYING PRIMARY DISPLAY DATA AND SECONDARY DISPLAY DATA

(76) Inventor: Richard Mottla, Carlsbad, CA (US)

Correspondence Address: STETINA BRUNDA GARRED & BRUCKER, 75 ENTERPRISE, SUITE 250, ALISO VIEJO, CA, 92656, US

(21) Appl. No.: 12/349,421

(22) Filed: Jan. 6, 2009

(51) Int. Cl. G09B 5/00

(52) U.S. Cl. 434/307 R

(57) ABSTRACT

Provided is an image generation system including a secondary data device having secondary display data stored thereon, and a console having a primary input communicable with a primary data source to receive primary display data therefrom. The console includes a secondary input communicable with the secondary data device to receive the secondary display data therefrom. A signal generator is in communication with the primary and secondary inputs for receiving the primary and secondary display data. The signal generator is configured to generate a display signal in a first mode for displaying images relating the primary display data and not the secondary display data, and a second mode for displaying images relating the primary display data and the secondary display data. The signal generator is configured to independently switch between generating the display signal in the first mode and the second mode.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

1. Field of the Invention

The present invention relates generally to an image generation system, and more specifically to a console configured to receive primary data from a primary data source as well as secondary data from a secondary data source and to display a primary image and a secondary image relating to the primary data and secondary data, respectively.

2. Description of the Related Art

An individual's intellectual development begins shortly after birth and continues throughout one's life. Intellectual development may include active learning, which may be exemplified by an individual's formal education. Traditionally, formal education begins with classroom-based instruction with a teacher instructing multiple students in various subjects. In this manner, students may perform tasks, such as projects, presentations, etc., as well as complete assigned work. In most classroom-based situations, the students are encouraged to actively participate in order to keep the students engaged throughout the learning process.

Although traditional classroom-based teaching may be an integral part of an individual's intellectual advancement, there may be some deficiencies associated with this teaching style. For instance, if a student becomes disengaged from the teacher's instruction (i.e., from boredom, lack of interest, etc.), the student may not grasp the concepts or content of the lesson. This is undesirable, especially with regard to young students as they are likely to have shorter attentions spans which allow them to become easily diverted from the task at hand. Furthermore, if the classroom includes a large number of students, one or more students may not be able to keep up with the pace of the curriculum. Therefore, one or more students may not receive the attention they need to completely understand the concepts taught by the instructor. Conversely, for gifted students, the pace of the curriculum may hold them back and restrict them from reaching their full potential.

In view of the foregoing drawbacks to traditional classroom-based education, other forms of intellectual development may be useful to supplement an individual's learning (i.e., classroom-based education). One form of intellectual development that differs from active learning is passive learning, which is distinguishable from active learning because it generally does not take place at a conscious level. In this manner, a fact or concept may be learned without realizing it.

Although learning does not require active participation by the individual, it is believed that there is little difference in brain activation during active and passive learning. Therefore, passive learning may be a useful learning strategy outside of traditional active learning environments (i.e., classrooms). Passive learning may be useful for a variety of different individuals, especially pre-grade school aged children, children on school breaks, or students studying for standardized exams.

Passive learning may be most effective when implemented into an activity which independently captivates an individual's attention. In the case of children that are school aged or younger, much of their free time is spent engaged with digital media. For instance, children may watch television shows, play video games, spend time on a computer, or watch a movie. In each instance, visual content is displayed on a display device (i.e., television or computer monitor) for viewing by a viewer. However, in most cases, the content displayed on the display devices does not further one's intellectual development.

As is apparent from the foregoing, there exists a need in the art for an improved learning system in comparison to the prior art.

### BRIEF SUMMARY OF THE INVENTION

According to an aspect of the present invention, there is provided an image generation system for use with a display device and a primary data source configured to transmit primary display data to the display device. The image generation system includes a secondary data device and a console. The secondary data device includes secondary display data stored thereon. The console includes a primary input that is communicable with the primary data source to receive the primary display data from the primary data source. The console additionally includes a secondary input communicable with the secondary data device to receive the secondary display data from the secondary data device. A signal generator is in communication with the primary input and the secondary input for receiving the primary display data and the secondary display data, respectively. The signal generator is configured to generate a display signal in a first mode and a second mode. The first mode includes data for displaying images relating the primary display data and not the secondary display data. The second mode includes data for displaying images relating the primary display data and the secondary display data. The signal generator is configured to independently switch between generating the display signal in the first mode and the second mode. The console further includes a display output in communication with the signal generator to receive the display signal from the signal generator, the display output being communicable with the display device to communicate the display signal to the display device.

The image generation system may allow a user to display a primary image and a secondary image on the display device. The primary image may include television programming, DVD movies, video games, Internet content, or other commonly viewed digital information. The secondary image may relate to educational data for a passive learning system, trivia questions, personalized information, or other content which may be desirable to display. The secondary image may be intermittently displayed with the primary image. In this manner, the secondary image may be superimposed over the primary image, or displayed alongside the primary image.

The secondary data device may additionally include a transmission controller in communication with the data storage unit to receive secondary display data from the data storage unit. The transmission controller may be operative to independently transmit the secondary display data in intermittent intervals.

The image generation system may further include a remote control configured to electronically communicate with the signal generator. The signal generator may be configured to switch between generating the display signal in the first mode and the second mode in response to electronic communication with the remote control. The signal generator may be configured to switch from generating the display signal in the second mode to the first mode. The primary display data relates to a primary image and the secondary display data relates to a secondary image. The signal generator may be configured to generate a display signal with the primary image being paused. The primary image may be paused after a pre-determined time period unless the signal generator electronically communicates with the remote control. The primary display data relates to a primary image being sized to define a primary footprint and the secondary display data relates to a secondary image being sized to define a secondary footprint. The signal generator may be configured to modify the relative sizing of the primary and secondary footprints after a pre-determined time period unless the signal generator electronically communicates with the remote control.

The present invention is best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings in which like numbers refer to like parts throughout and in which:

FIG. 1 is a perspective view of an image generation system including a secondary data device and a console, the console being connectable to a display device and a primary data source;

FIG. 2 is a schematic diagram of the secondary data device and the console;

FIG. 3A is a front view of the console;

FIG. 3B is a rear view of the console;

FIGS. 4A-4C illustrate a chronological sequence of images displayed on the display device, in FIG. 4A, the display device displaying images relating to primary display data, in FIG. 4B, the display device displaying images relating to both primary display data and secondary display data, in FIG. 4C, the display device displaying images relating to primary display data; and

FIG. 5 is a schematic diagram illustrating a display signal first mode and a display signal second mode.

### DETAILED DESCRIPTION OF THE INVENTION

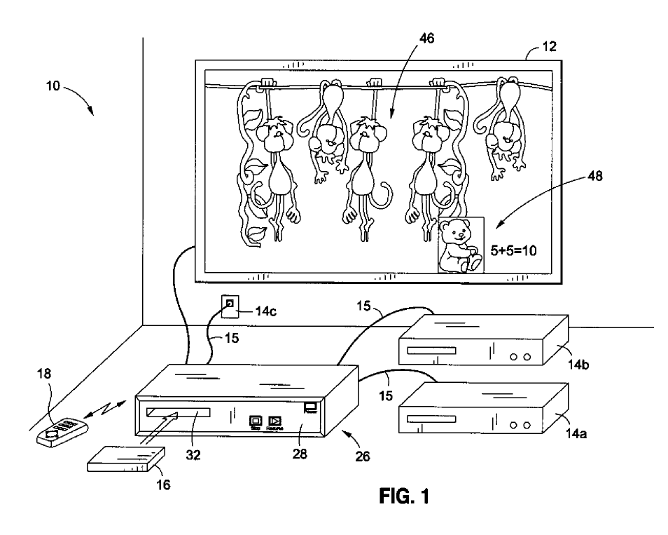

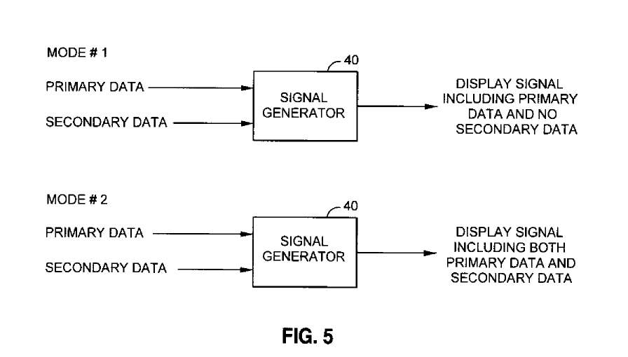

Referring now to the drawings wherein the showings are for purposes of illustrating a preferred embodiment of the present invention only, and not for purposes of limiting the same, FIGS. 1-5 illustrate an image generation system 10 constructed in accordance with an embodiment of the present invention. The image generation system 10 is configured to display primary display content (i.e. regular television programming, a digital video disk (DVD) movie, a video game, etc.) as well as secondary display content. The secondary display content may take on many forms, such as passive learning content, trivia (sports, entertainment, general trivia), factual information, or personalized data (i.e., family photos).

Referring now specifically to FIG. 1, there is shown a system level view of the image generation system 10. According to one embodiment, the image generation system 10 includes a secondary data device 16 and a console 26. A remote control 18 may also be provided that is used to electronically communicate with the console 26. The console 26 is communicable with a primary data source, such as any of the exemplary primary data sources 14a, 14b, 14c. As used herein, the primary data source 14 refers to an input that is capable of communicating data to the console 26 for display on a display device 12. Exemplary primary data sources 14 may include, but are not limited to, a cable outlet, a satellite feed, a DVD player, a video game console, a digital video recorder, and an Internet outlet.

The primary data sources 14 are disposed in electrical communication with the console 26. Communication between the console 26 and the primary data source 14 may be achieved through electrical conduits 15 extending respectively between the primary data source 14 and the console 26, similar to the wired communication between a conventional set top box and a DVD player, cable outlet, or video game system. It is also contemplated that communication between the console 26 and the primary data source 14 may be achieved via wireless communication, such as Bluetooth®, WiFi, or other wireless communication means. Wireless communication between the console and the primary data source 14 may be desirable when the primary data source 14 is an Internet outlet, or a wireless communication device, such as a personal digital assistant (PDA), telephone, camera or video camcorder. Data from the wireless communication device or Internet outlet may be wirelessly communicated to the console 26 for display on the display device 12.

The display device 12 is connected to the console 26 and is capable of displaying images 46 related to the data received from the primary data sources 14 and the secondary data device 16 as described in more detail below. A display device 12 may include an electronic display configured to present information for visual perception. Display devices 12 may include televisions, computer monitors, L.E.D. panels, or other display apparatus known by those skilled in the art.

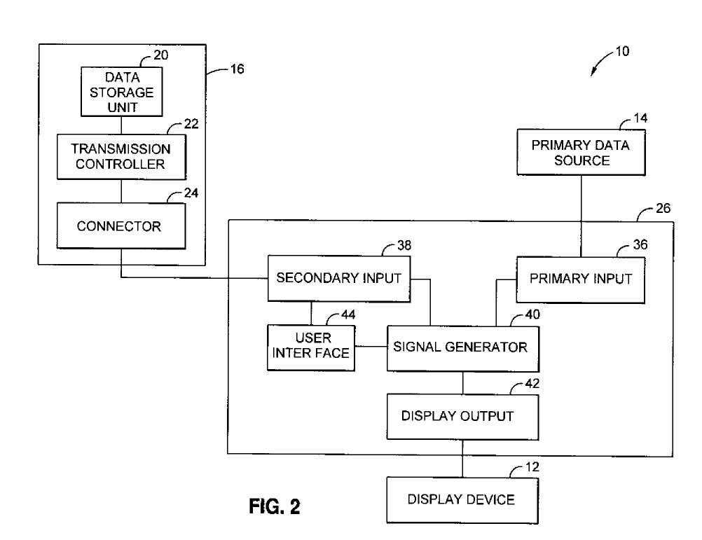

Referring now to FIG. 2, there is shown a schematic diagram of the image generation system 10. The secondary data device 16 is shown in more detail, and includes a data storage unit 20 for storing secondary display data thereon. The data storage unit 20 may include RAM memory, ROM memory, FLASH memory, a hard disk or other data storage devices known by those skilled in the art. The data storage unit 20 may be capable of temporary data storage or long-term data storage. The secondary display data stored on the data storage unit 20 may relate to a wide range of topics or subjects. For instance, in one embodiment, the secondary display data may relate to a passive learning system. In this manner, each secondary data device 16 may include educational data relating to a particular subject and may be specifically tailored for a particular grade or level. For instance, one secondary data device 16 may be intended for use by preschool aged children and may include secondary display data for introducing the child to basic colors or animals. The secondary data device 16 may also be intended for use by elementary aged children, and includes secondary display data related to the alphabet or simple math. It is also contemplated that the secondary data device 16 may useful to high school or college aged individuals and include secondary display data relating to historical dates and events or scientific facts. The secondary data device 16 may also be useful in preparing the student for standardized exams, such as the SAT, ACT, GMAT, LSAT, GRE, or MCAT by including secondary display data related to common themes, principals, vocabulary, definitions, or facts tested on those exams. It is understood that the foregoing examples are exemplary in nature only, and are not intended to limit the content and scope of subjects which the secondary display data may relate to. In this manner, the secondary display data may relate to any topic or subject, not merely the topics or subjects previously mentioned.

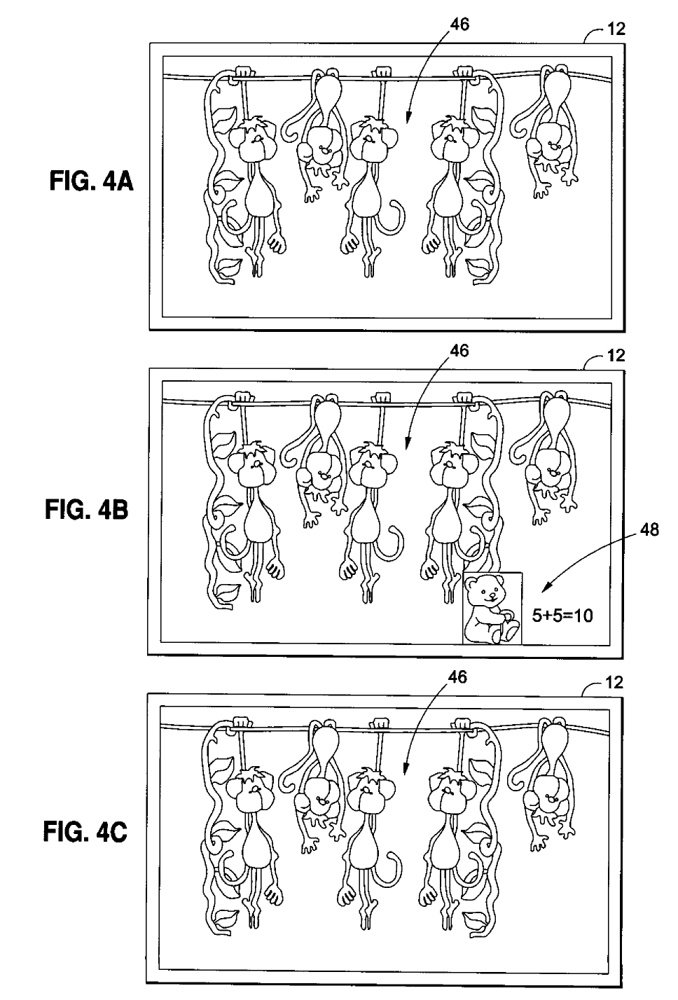

As described in more detail below, images 48 relating to the secondary display data may be displayed on the display device 12 along with images 46 relating to the primary display data. Therefore, in the case of a passive learning system, images 48 relating to the alphabet, colors, algebra or other topics/subjects may be displayed along with the primary display images 46. In this manner the passive learning system may be used while watching regular network television, playing a video game, watching a movie, or spending time on the computer. The images 48 relating to the secondary display data may intermittently flash on the display device 12, while images 46 relating to the primary display data are also shown on the display device 12. For instance, FIGS. 4A-4C is a sequence of images 46, 48 shown on the display device 12. In FIG. 4A, images 46 relating solely to the primary display data are shown. In FIG. 4B, images 48 relating to the secondary display data pop-up on the display device 12, and are superimposed over the images 46 relating to the primary display data. Finally, in FIG. 4C, the images 48 relating to the secondary display data disappear, leaving the images 46 relating to the primary display data. As such, a parent or child caretaker may require that the child use the passive learning system while watching television or playing video games.

Although it may be desirable to store data relating to a passive learning system on the data storage unit 20, it may also be desirable to use the image generation system 10 for other purposes. For instance, the secondary data device 16 may be used as a trivia game, with the secondary display data relating to trivia questions or facts. More specifically, the secondary display data may relate to sports trivia about a particular team or sport. In this manner, sports related trivia questions or facts may appear on the display device 12 while a user watches his/her favorite teams compete. In that case, the broadcast of the competition/game is the primary display data, while the secondary display data relates to the sports trivia questions. Other embodiments may include secondary data devices 16 having trivia related to movies, video game trivia or tips, history trivia, sitcom trivia, or other subjects stored on the secondary data devices 16.

It is also contemplated that the secondary data device 16 may include secondary display data that relates to personal information about the user. In this manner, the secondary display data may relate to personal photos or movies, which may be displayed along with images 46 relating to primary display data. For instance, personal photographs may be displayed on the display device 12 while a user watches television.

Although the foregoing illustrates that the secondary display data may relate to a passive learning system, a trivia game, or personalized data, it is understood that the secondary display data is not limited thereto and may relate to other subjects or topics that may be desirable.

The secondary display data is stored on a data storage unit 20. In this manner, the secondary data device 16 may be purchased with the secondary display data already stored on the data storage unit 20. For instance, a parent may purchase a secondary data device 16 having a data storage unit 20 with secondary data relating to the alphabet already stored on the data storage unit 20.

It is also contemplated that the data storage unit 20 may be writeable. In other words, content may be added to the data storage 20 unit by a user. Secondary display data may be downloaded from a computer, Internet, cable outlet, or other destination. Therefore, a user may purchase blank data storage units 20 and download content onto the data storage unit 20. In this manner, the data storage unit 20 may be communicable with the source of secondary display data. It is also contemplated that secondary display data may be deleted from an existing data storage unit 20 in order to create space for new secondary display data. It is also contemplated that the data storage unit 20 may be removable from a secondary data device 16. In this manner, a single secondary data device 16 may be used with a wide range of data storage units 20 that cover a wide range of topics and subjects. As such, the data storage unit 20 may include a chip or cartridge that is removably engageable with the external data device 16.

The external data device 16 is configured to communicate the secondary display data to the console 26. To this end, the secondary data device 16 includes a connector 24 in communication with the data storage unit 20. The connector 24 is communicable with the console 26 to facilitate communication between the secondary data device 16 and the console 26. The console 26 includes a secondary input 38 that is communicable with the connector 24. In this manner, the connector 24 may physically engage with the console 26 to enable communication between the console 26 and the secondary data device 16. In other implementations, the connector 24 may be configured to wirelessly communicate with the console 26 to achieve wireless communication therebetween. As such, communication between the secondary data device 16 and the console 26 may be achieved without mechanical engagement therebetween. In another embodiment, the secondary data device 16 may be integrated with the console 26. In this regard, the console 26 may be pre-programmed with secondary display data.

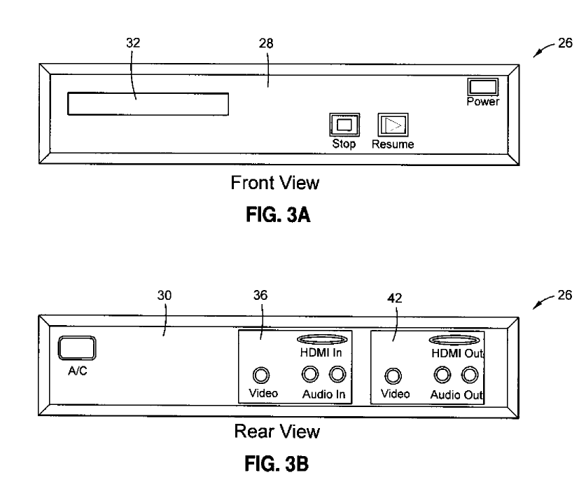

Referring now to FIGS. 3A and 3B, there is shown one embodiment of the console 26 including a console front 28 and a console back 30. The console front 28 includes a slot 32 for receiving the secondary data device 16. In this manner, communication between the console 26 and the secondary data device 16 is achieved by inserting the secondary data device 16 into the slot 32. With regard to the consol back 30, there is shown a plurality of primary inputs 36 which may include an outlet or jack for receiving a cable such as a satellite input, cable input, DVD input, Internet input or video game input. The primary input 36 may also be able to receive wireless communications from a primary data source 14 such as a digital camera or recorder.

Referring back to FIG. 2 the secondary input 38 and the primary input 36 are both in communication with a signal generator 40. In this manner, the signal generator 40 receives primary display data from the primary input 36 and secondary display data from the secondary input 38. The signal generator 40 receives the primary display data and secondary display data and generates a display signal for display on the display device 12. In one embodiment of the invention, the signal generator 40 is configured to generate the display signal in a first mode and second mode. The first mode includes data for display images 46 relating to the primary display data and not the secondary display data. In the second mode, the display signal includes data for displaying images 46, 48 relating to the primary display data and the secondary display data. In this manner, images 46, 48 relating to the primary display data as well as the secondary display data are perceivable on the display device 12. With regard to the first mode, it is understood that the secondary display data may be included in the display signal, yet images 48 relating to the secondary display data may not be displayed on the display device 12. Furthermore, the display signal may additionally include other data which may not relate to images 46, 48 displayed on the display device 12, such as a header or footer.

In the first mode, images 48 relating to the secondary display data are not illustrated on the display device 12. Therefore, if a user is simply watching a movie or regular television programming, without images 48 relating to a secondary display data also shown on the display device 12, the signal generator 40 is generating a display signal in the first mode. The secondary data device 16 may not be connected to the console 26 and the signal generator 40 may only be receiving data from the primary input 36. Alternatively, the secondary data device 16 may be connected to the console 26 and the signal generator 40 may be receiving data from both the secondary input 38 and the primary input 36. However, the signal generator 40 may generate a display signal for displaying images 46 relating to the primary display data and not the secondary display data.

In the second mode, the signal generator 40 receives data from both the secondary input 38 and the primary input 36. The signal generator 40 constructs a display signal that includes data for displaying images 46, 48 relating to both the primary display data and the secondary display data.

The signal generator 40 is configured to independently switch between generating a display signal in the first mode and the second mode. As used herein, the term independently switch refers to the system at least transitioning from generating a display signal in the first mode to the second mode without direct initiation by the user at the time of such transition. In other words, while the user may indeed control the powering up of the secondary data device 16, the user may not exactly control when the images 48 related to the secondary display data is delayed on the display device 12. The term independently switch may also refer to the system transitioning from generating a display signal in the second mode to the first mode.

The signal generator 40 may be configured to intermittently and independently switch between generating a display signal in the first mode and the second mode. In other words, the signal generator 40 may switch between the first mode and second mode without input by the user. For instance, the signal generator 40 may construct a display signal in the first mode for a first period of time. After the first period of time has expired, the signal generator 40 may construct a display signal in the second mode for a second period of time. At the expiration of the second period of time, the signal generator 40 may revert back to constructing the display signal in the first mode. The length of the first period of time and the second period of time may be preprogrammed into the signal generator 40 as a preprogrammed timing sequence. For instance, the signal generator 40 may construct the display signal in the first mode for twenty seconds. At the expiration of the twenty seconds, the signal generator 40 may generate the display signal in the second mode for ten seconds.

Given that images 46 related to the primary display data are shown in both the first mode and the second mode, the images 46 relating to the primary display data appear to be continuously displayed even as the signal generator 40 switches between the first mode and the second mode. Since the images 48 relating to the secondary display data are only shown when the signal generator 40 generates the display signal in the second mode, the images 48 relating to the secondary display data may intermittently appear on the display device 12. However, the signal generator 40 may be configured to continuously display images 48 relating to the secondary display data upon receipt of secondary display data from the secondary input 38.

The console 26 may include a user interface 44 to allow a user to control the switching between the first mode and the second mode. For instance, the user may input the length of the first display period and the second display period through the user interface 44. Alternatively, the signal generator 40 may have a series of preprogrammed timing sequences which the user may select through the user interface 44.

Although the foregoing describes the signal generator 40 configured to switch between generating a display signal in a first mode and a second mode, it is contemplated that the intermittent transmission of data for displaying images 48 related to the secondary display data may be controlled by the secondary data device 16. In this manner, the signal generator 40 may simply combine the data received from the secondary input 38 and the primary input 36 to generate the display signal. More specifically, one embodiment of the invention includes a secondary data device 16 having a transmission controller 22 in communication with the data storage unit 20 and the connector 24. The transmission controller 22 is operative to independently transmit the secondary display data from the data storage unit 20 for reception by the secondary input 38. As shown in FIG. 2, the transmission controller 22 is integrated into the secondary data device 16. In other embodiments, the transmission controller 22 may be disposed between the secondary data device 16 and the console 26. In this manner, the transmission controller 22 may determine when secondary display data is communicated from the secondary data device 16 to the console 26.

After the display signal is generated by the signal generator 40, the display signal is communicated to a display outlet 42. In this manner, the signal generator 40 is in communication with the display outlet 42. The display outlet 42 is also communicable with the display device 12 to communicate the display signal thereto.

As mentioned above, a remote control 18 may be provided. The remote control 18 may be used to control the console 26. The remote control 18 may be used to receive inputs from the user and such inputs may be used by the signal generator 40. The image generation system 10 may be configured to require the user to interact with the image generation system 10 by using the images 48 related to the secondary display data. For example, the user may be prompted to answer a question by the secondary image 48. The user may then use the remote control 18 to input a response. A correct response may then be interpreted by the signal generator to switch from the second mode to the first mode thereby removing the images related to the secondary display data. In this manner, the image generation system 10 may be configured in a more active learning configuration which rewards the user by removing the images related to the secondary display data in order to view the images related to the primary display data in an encumbered manner. Further variation of this configuration would be to pause the primary images 46 until user input is received via the remote control 18. For example, if the user does not respond to the displayed images 48 related to the secondary display data after some pre-determined time period or incorrect responses are received via the remote control 18, the primary images 46 may be paused. In another variation, if the user does not respond to the displayed images 48 related to the secondary display data after some pre-determined time period or incorrect responses are received via the remote control 18, the relative sizing of the images 46, 48 related to the primary and secondary display data may be changed.

Although the foregoing specifically describes a primary data source 14 configured to supply primary display data, it is understood that the primary data source 14 may also supply primary audio data that corresponds to the primary display data. Likewise, the secondary data device 16 may not only supply secondary display data, but also secondary audio data that corresponds to the secondary display data. For instance, in a case of a passive learning system for teaching simple math principles, the secondary display data may simply relate to an image of an icon representing the mathematical equation five plus five equals ten. Corresponding secondary audio data may include a voice which states, “five plus five equals ten” when the icon appears on the display device 12.

It is understood that the size and location of the image 48 relating to the secondary display data may vary. In particular, the image 48 relating to the secondary display data may be displayed anywhere on the display device 12. However, it is assumed that in most cases, the image 46 relating to the primary display data will be displayed across the entire viewing area. For instance, the image 46 relating to the primary display data may be displayed across the entire television screen or computer monitor. Therefore, the image 48 relating to the secondary display data may be superimposed over the image 46 relating to the primary display data on the display device 12. Given that the secondary image 48 is superimposed over the primary image 46, it may be desirable for the secondary image 48 to be partially transparent to allow for perception of the primary image 46. Furthermore, it may be desirable to display the secondary image 48 along the periphery of the primary image 46. In addition, the footprint or overall area defined by the secondary image 48 may be different than a footprint or area defined by the primary image 46. For example, the footprint or area defined by the secondary image 48 may be smaller than the footprint or area defined by the primary image 46. It is contemplated that the footprint of the primary image 46 may be different when in the first and second modes.

Operation of the image generation system 10 will now be described. A console 26 having a primary input 36 and a secondary input 38 is provided. The primary input 36 is connectable to one or more primary data sources 14. A secondary data device 16 is also provided and includes a data storage unit 20 and a connector 24. The connector 24 is operatively connected to the secondary input 38 to allow secondary displayed data stored on the data storage unit 20 to be communicated to the console 26. Communication between the secondary data device 16 and the console 26 may be achieved by inserting the secondary data device 16 into a slot 32 formed in the console 26. In one embodiment, the secondary data device 16 includes a transmission controller 22 which controls communication of secondary display data from the data storage unit 20 to the console 26. In another embodiment, communication of secondary display data is continuously sent from the data storage unit 20 to the console 26, so long as the secondary data device 16 remains connected to the console 26. The primary display data and secondary display data are communicated to a signal generator 40 located in the console 26. In one embodiment, the signal generator 40 generates a display signal in a first mode and a second mode. In the first mode, the display signal includes data for displaying an image 46 relating to the primary display data but not the secondary display data. In the second mode, the display signal includes data for displaying images 46, 48 relating to the primary display data and the secondary display data. The constructed display signal is communicated from the signal generator 40 to the display output 42, which is communicable with a display device 12. When the display device 12 is connected to the display output 42, the display signal is received by the display device 12 and the primary and/or secondary display images 46, 48 are displayed on the display device 12.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An image generation system for use with a display device and a primary data source configured to transmit primary display data to the display device, the image generation system comprising:
a secondary data device having secondary display data stored thereon; and
a console having:
a primary input communicable with the primary data source to receive the primary display data from the primary data source;
a secondary input communicable with the secondary data device to receive the secondary display data from the secondary data device;
a signal generator in communication with the primary input and the secondary input for receiving the primary display data and the secondary display data, respectively, the signal generator being configured to generate a display signal in a first mode and a second mode, the first mode including data for displaying images relating the primary display data and not the secondary display data, the second mode including data for displaying images relating the primary display data and the secondary display data, the signal generator configured to independently switch between generating the display signal in the first mode and the second mode; and
a display output in communication with the signal generator to receive the display signal from the signal generator, the display output being communicable with the display device to communicate the display signal to the display device.

2. The image generation system of claim 1 wherein the secondary data device includes:
a data storage unit configured to store the secondary display data; and
a transmission controller in communication with the data storage unit to receive secondary display data from the data storage unit, the transmission controller being operative to independently transmit the secondary display data in intermittent intervals.

3. The image generation system of claim 1 wherein the primary display data relates to a primary image being sized to define a primary footprint and the secondary display data relates to a secondary image being sized to define a secondary footprint, the secondary footprint being smaller than the primary footprint.

4. The image generation system of claim 1 wherein the primary display data relates to a primary image and the secondary display data relates to a secondary image, the secondary image being superimposed on top of the primary image.

5. The image generation system of claim 4 wherein the secondary image is partially transparent.

6. The image generation system of claim 1 wherein the signal generator is configured to independently switch from generating the display signal in the first mode to the second mode.

7. The image generation system of claim 1 wherein the secondary data device further includes secondary audio data stored thereon, the secondary audio data being complimentary to the secondary display data.

8. The image generation system of claim 7 wherein the second mode of the display signal further includes data for playing audio related to the secondary audio data.

9. The image generation system of claim 1 wherein the secondary input includes a slot, at least a portion of the secondary data device being received within the slot to facilitate communication between the secondary data device and the primary input.

10. The image generation system of claim 1 wherein the signal generator independently switches between generating the display signals in the first mode and the second mode in response to a preprogrammed switching schedule.

11. The image generation system of claim 1 further including a user interface in communication with the signal generator, the user interface configured to allow a user to input switching instructions, the signal generator configured to independently switch between generating the display signal in the first mode and the second mode in response to the switching instructions.

12. The image generation system of claim 1 further including a remote control configured to electronically communicate with the signal generator, the signal generator configured to switch between generating the display signal in the first mode and the second mode in response to electronic communication with the remote control.

13. The image generation system of claim 12 wherein the signal generator is configured to switch from generating the display signal in the second mode to the first mode.

14. The image generation system of claim 12 wherein the primary display data relates to a primary image and the secondary display data relates to a secondary image, the signal generator is configured to generate a display signal with the primary image being paused.

15. The image generation system of claim 12 wherein the signal generator is configured to generate a display signal with the primary image being paused after a pre-determined time period unless the signal generator electronically communicates with the remote control.

16. The image generation system of claim 12 wherein the primary display data relates to a primary image being sized to define a primary footprint and the secondary display data relates to a secondary image being sized to define a secondary footprint, the signal generator is configured to modify the relative sizing of the primary and secondary footprints after a pre-determined time period unless the signal generator electronically communicates with the remote control.

17. A secondary data device for use with a signal generator configured to receive data from multiple data sources and construct a single display signal for display on a display device, the secondary data device comprising:
a data storage unit including display data stored thereon; and
a transmission controller communicable with the signal generator and in communication with the data storage unit to receive display data from the data storage unit, the transmission controller being operative to independently transmit the display data in intermittent intervals to the signal generator.

18. The image generation system of claim 17 wherein the data storage unit further includes secondary audio data stored thereon, the secondary audio data being complimentary to the secondary display data.

19. The image generation system of claim 18 wherein the transmission controller transmits secondary audio data to the signal generator along with the display data.
